(19) United States
(12) Patent Application Publication
(10) Pub. No.: US 2009/0147397 A1
(43) Pub. Date: Jun. 11, 2009

(54) PATTERNED MAGNETIC RECORDING MEDIUM AND METHOD OF RECORDING TRACK INFORMATION ONTO THE SAME

(75) Inventors: Hae-sung Kim, Hwaseong-si (KR); Jun Jeong, Suwon-si (KR); Hyun-seok Yang, Seoul (KR); No-cheol Park, Seoul (KR); Jin-seung Sohn, Seoul (KR); Sang-chul Sul, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/100,012

(22) Filed: Apr. 9, 2008

(30) Foreign Application Priority Data
Dec. 7, 2007 (KR) 10-2007-0126909

(51) Int. Cl. G11B 5/58

(52) U.S. Cl. 360/77.01

(57) ABSTRACT

Provided are a patterned magnetic recording medium and a method of recording track information onto the patterned magnetic recording medium. The patterned magnetic recording medium includes: a data sector comprising a plurality of magnetic recording regions which are spaced apart from one another, wherein the magnetic recording regions constitute a plurality of tracks which are each shaped like a ring; and a servo sector comprising servo patterned regions and correction code regions, which are each provided on each of the plurality of tracks, wherein information regarding a track that is to be actually used in a hard disk drive (HDD) is recorded on a correction code region of at least one track of the plurality of tracks.

### CROSS-REFERENCE TO RELATED PATENT APPLICATION

This application claims priority from Korean Patent Application No. 10-2007-0126909, filed on Dec. 7, 2007 in the Korean Intellectual Property Office, the disclosure of which is incorporated herein in its entirety by reference.

### BACKGROUND OF THE INVENTION

1. Field of the Invention

The present invention relates to a patterned magnetic recording medium including a data sector patterned thereon, wherein information is recorded on the data sector, and a method of recording track information onto the patterned magnetic recording medium.

2. Description of the Related Art

Hard disk drives (HDDs) that use magnetic recording media have a large recording capacity and high access speed. As a result, they have received much attention for use as information memory apparatuses not only for computers but also for various other digital apparatuses. Recently, due to the widespread use of information systems, the amount of information exchanged over various networks has increased enormously. Thus, there is a need for high density HDDs to be developed.

As the recording density increases, the bit size, which is the minimum recording unit of data, has to be reduced, and accordingly, the intensity of magnetic signals generated from a recording medium is weakened. As a magnetic recording medium overcoming these problems and having the increased recording density, patterned magnetic recording media such as discrete track media or bit patterned media have been proposed, wherein a patterned magnetic recording medium includes a plurality of data sectors that are spaced apart from one another so that noise generated by a medium is reduced, thereby maintaining a high signal to noise ratio (SNR).

Servo information needs to be previously written to a magnetic recording medium so that a magnetic head is correctly positioned at a desired position of the magnetic recording medium. A method of recording servo information can be largely classified into an off-line method and an on-line method. In the off-line method, servo information is written before a head disk assembly is assembled, that is, when a magnetic recording medium is not loaded on an HDD. In the on-line method, servo information is written after the head assembly is assembled.

Since the off-line method is simultaneously performed with respect to a plurality of disks, a period of time required for processes to be performed can be remarkably reduced. However, various errors may be generated. For example, the center of tracks does not match a center of rotation of a spindle motor due to various mechanical tolerances which may be generated when a head disk assembly is assembled. In addition, a magnetic head may not be correctly moved to an innermost track or an outermost track of the HDD. In the on-line method, since servo information is written after a head disk assembly is assembled, the above-described mechanical tolerances are not a problem. However, a long period of time is required for recording servo information.

Generally, in a patterned magnetic medium including a data sector patterned in predetermined patterns, servo information is recorded using the off-line method. That is, in a method of manufacturing a patterned magnetic recording medium, servo information of a servo region is simultaneously formed as servo patterns that are physically patterned when patterning the data sector. Accordingly, there is a need to render information regarding tracks that are to be actually used after a head disk assembly is assembled to a patterned magnetic medium.

### SUMMARY OF THE INVENTION

The present invention provides a patterned magnetic recording medium and a method of recording track information onto the patterned magnetic recording medium.

According to an aspect of the present invention, there is provided a patterned magnetic recording medium comprising: a data sector comprising a plurality of magnetic recording regions which are spaced apart from one another, wherein the magnetic recording regions constitute a plurality of tracks which are each shaped like a ring; and a servo sector comprising a servo patterned region and a correction code region, which are each provided on the tracks, wherein information regarding a track that is to be actually used in an HDD is recorded on at least one track of the correction code region, which is selected from among the tracks.

According to another aspect of the present invention, there is provided a patterned magnetic recording medium comprising: a data sector comprising a plurality of magnetic recording regions which are spaced apart from one another, wherein the magnetic recording regions constitute a plurality of tracks which are each shaped like a ring; a servo sector comprising servo pattern regions which are each provided on the tracks; and a maintenance cylinder (MC) region provided for recording information required for driving an HDD on a part of the tracks, wherein information regarding a track that is to be actually used in the HDD is recorded in the MC region.

According to another aspect of the present invention, there is provided a method of recording track information, the method comprising: preparing a patterned magnetic recording medium comprising a data sector including a plurality of magnetic recording regions spaced apart from one another and a servo sector including a servo patterned region and a correction code region, wherein the magnetic recording regions constitute a plurality of tracks which are each shaped like a ring, and the servo patterned region and the correction code region are each provided on the tracks; loading the patterned magnetic recording medium in an HDD and measuring a track range which is to be actually used in the HDD; and recording information regarding the measured track range on at least one track of a correction code region, which is selected from the tracks.

According to another aspect of the present invention, there is provided a method of recording track information, the method comprising: preparing a patterned magnetic recording medium comprising a data sector including a plurality of magnetic recording regions spaced apart from one another and a servo sector including a servo patterned region and a correction code region, wherein the magnetic recording regions constitute a plurality of tracks which are each shaped like a ring, and the servo patterned region and the correction code region are each provided on the tracks; loading the patterned magnetic recording medium in an HDD and measuring a track range which is to be actually used in the HDD; and determining an MC region on a track in the vicinity of the center between an innermost track and an outermost track, which are selected from among tracks within the track range, which is to be actually used.

### BRIEF DESCRIPTION OF THE DRAWINGS

The above and other aspects of the present invention will become more apparent by describing in detail exemplary embodiments thereof with reference to the attached drawings in which:

FIG. 1 is a plan view of a patterned magnetic recording medium according to an exemplary embodiment of the present invention;

FIG. 2 is an enlarged perspective view of an area A illustrated in FIG. 1;

FIG. 3 is a plan view of a patterned magnetic recording medium according to another exemplary embodiment of the present invention;

FIG. 4 is an enlarged perspective view of an area A illustrated in FIG. 3;

FIG. 5 is a block diagram illustrating a schematic structure of a hard disk drive (HDD) performing a method of recording track information, according to an exemplary embodiment of the present invention;

FIG. 6 is a flow chart of a method of recording track information according to an exemplary embodiment of the present invention; and

FIG. 7 is a flow chart of a method of recording track information according to another exemplary embodiment of the present invention.

### DETAILED DESCRIPTION OF EXEMPLARY EMBODIMENTS OF THE INVENTION

Hereinafter, the present invention will be described in detail by explaining exemplary embodiments of the invention with reference to the attached drawings. The same reference numerals in the drawings denote the same element. In the drawings, the thicknesses of layers and regions are exaggerated for clarity.

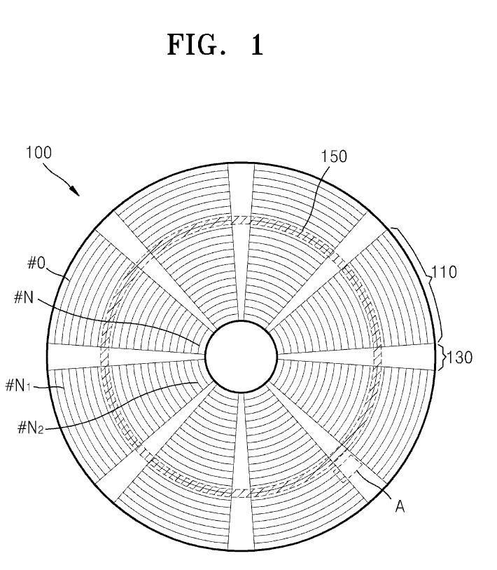

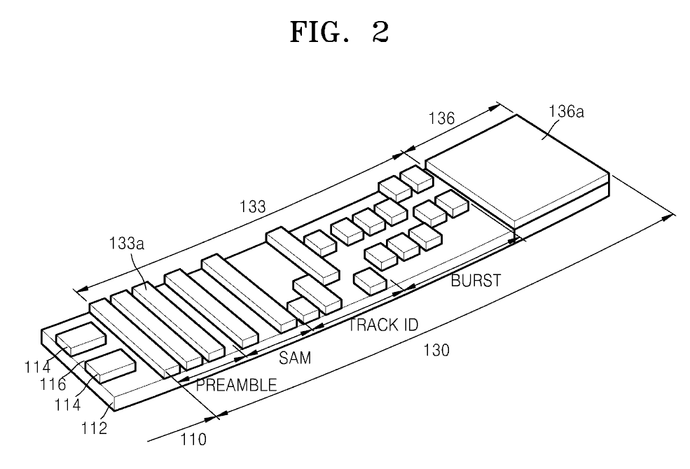

FIG. 1 is a plan view of a patterned magnetic recording medium 100 according to an exemplary embodiment of the present invention. FIG. 2 is an enlarged perspective view of an area A illustrated in FIG. 1. Referring to FIGS. 1 and 2, the patterned magnetic recording medium 100 includes a data sector 110 and a servo sector 130.

The data sector 110 includes a plurality of magnetic recording regions 114 spaced apart from one another on a substrate 112, wherein the magnetic recording regions 114 constitute a plurality of tracks which are each shaped like a ring. The magnetic recording regions 114 are spaced apart from one another only in a cross-track direction, i.e., in a direction crossing the tracks, but extend in a down-track direction, i.e., in a direction parallel to the tracks. Since the magnetic recording regions 114 are discrete on a track by track basis, the patterned magnetic recording medium 100 is referred to as a discrete track medium. In FIGS. 1 and 2, the magnetic recording regions 114 are spaced apart from one another by grooves 116, and nothing is in the grooves 116. However, according to the present invention, the grooves 116 may be filled with a non-magnetic material.

The servo sector 130 is a region on which servo information regarding the tracks can be written along the tracks, and includes a servo patterned region 133 and a correction code region 136, which are each provided on the tracks.

The servo patterned region 133 includes patterned magnetic recording layers 133a which are patterned in predetermined patterns, and the patterned magnetic recording layers 133a contains servo information. For example, by magnetizing the patterned magnetic recording layers 133a, the servo information can be written by using a bit combination including a signal “1” for a magnetized region and a signal “0” for a non-magnetized region. For example, the servo patterned region 133 may include a preamble providing servo-synchronization, a servo address mark (SAM) signaling the beginning of the servo sector 130 and then providing synchronization for reading a gray code subsequent to the SAM, the gray code providing a track identification (ID), and a burst providing information for calculating a dimensional error signal required for following the tracks, as illustrated in FIG. 2. However, the shapes of the servo patterned regions 133 illustrated in FIG. 1 are merely exemplary, and various changes in form and detail can be made.

The correction code region 136 is a region on which a repeatable runout (RRO) correction code can be recorded. The RRO is an error that can be generated when a magnetic head cannot correctly follow the tracks. This is because the center of the tracks does not match a center of rotation due to a mechanical tolerance when the patterned magnetic recording medium 100 is driven on an HDD. The RRO is detected by using a signal generated from the burst. Thus, the correction code region 136 is used for recording a code for compensating the RRO so that the magnetic head can correctly follow the tracks. Generally, since the servo patterned region 133 is simultaneously formed when the magnetic recording regions 114 of the data sector 110 are patterned, and information is contained in the form of the patterned magnetic recording layers 133a, the information cannot be changed. On the other hand, since a correction code is recorded on the correction code region 136 according to the RRO that is measured when the HDD is driven, a continuous magnetic recording layer 136a constitutes the correction code region 136, wherein the continuous magnetic recording layer 136a has no pattern so that the contents of the correction code can be changed.

With regard to recording servo information on the servo patterned region 133, track regions of the patterned magnetic recording medium 100 are determined, and the servo information regarding the respective tracks is formed during an off-line state, i.e., when the patterned magnetic recording medium 100 is not loaded in the HDD. For example, a track ID of an outermost track is set as #0, and the number of a track ID is increased towards an innermost track. Servo information is formed as servo patterns. In FIG. 1, the innermost track is illustrated as #N. In this case, a track range #0 through #N, which is set during the off-line state, is different from a track range, which is to be actually used on the HDD. In FIG. 1, with regard to the track range, which is to be actually used on the HDD, an outermost track is illustrated as #N1, and an innermost track is illustrated as #N2. Likewise, considering various mechanical tolerances, the track range is set during the off-line state to be broader than the track range which is to be actually used on the HDD. If servo information is written with regard to only the necessary number of tracks, it is likely that the magnetic head cannot be moved to the innermost track or to the outermost track of the tracks set in the off-line state, when the patterned magnetic recording medium 100 is loaded on the HDD. In addition, if track regions used for writing the servo information are determined by considering the mechanical tolerance, a region used for recording data is reduced by as much as a region corresponding to the considered mechanical tolerance. The track range #N1 through #N2, which is to be actually used on the HDD, is determined by measuring track regions on which the magnetic head can be moved when the patterned magnetic recording medium 100 is loaded in the HDD.

As described above, since servo information is written in the form of the servo patterns in the patterned magnetic recording medium 100, a track having a track ID that is previously determined and written cannot be again written to a new track ID. Thus, new track information is required for driving the HDD, wherein the new track information is, for example, information regarding that the track #N1, which is previously written, is a new outermost track, and the track #N2 is a new innermost track. In the current exemplary embodiment, the new track information is recorded on predetermined regions of the patterned magnetic recording medium 100. For example, the new track information may be recorded on the correction code region 136. Information regarding a new track, that is, information that is to be actually used on the HDD is recorded on at least one track of the correction code region 136. The at least one track may be positioned at any position so long as the new track information of the at least one track can be read without the influence of the mechanical tolerance. The RRO correction code may be simultaneously recorded on the at least one track of the correction code region 136 on which the information is recorded, or alternatively, may not be recorded.

In addition, in the patterned magnetic recording medium 100, parts of track regions of the data sector 110 and the servo sector 130 are each set as a maintenance cylinder (MC) region 150. The MC region 150 is a region used for recording various data for smoothly driving the HDD. For example, information regarding a defect list and a channel optimization value of the data sector 110, or the like can be recorded on the MC region 150. In the patterned magnetic recording medium 100, information regarding the position of the correction code region 136 can be recorded on the MC region 150, wherein information regarding tracks that are to be actually used on the HDD is recorded on the correction code region 136.

Alternatively, information regarding the tracks that are to be actually used on the HDD may be recorded on the MC region 150, instead of the correction code region 136.

In the patterned magnetic recording medium 100, the MC region 150 is positioned on a track in the vicinity of the center between the outermost track and the innermost track, unlike in the case where the outermost track and the innermost track of a recordable region are used as the MC region 150. For example, the MC region 150 may be positioned at any position so that the magnetic head can reach the MC region 150 without the influence of the mechanical tolerance. This is because if the MC region 150 is positioned in the vicinity of the innermost track or the outermost track, it is likely that the magnetic head cannot be moved to the innermost track or the outermost track due to the mechanical tolerance generated when the HDD is assembled and driven. In addition, this is because such a mechanical tolerance may be different according to an HDD.

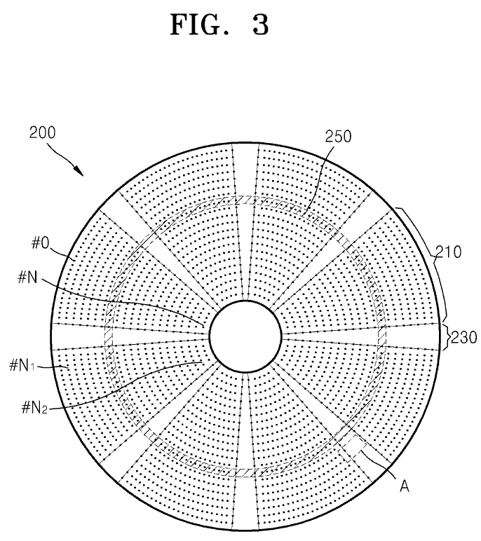

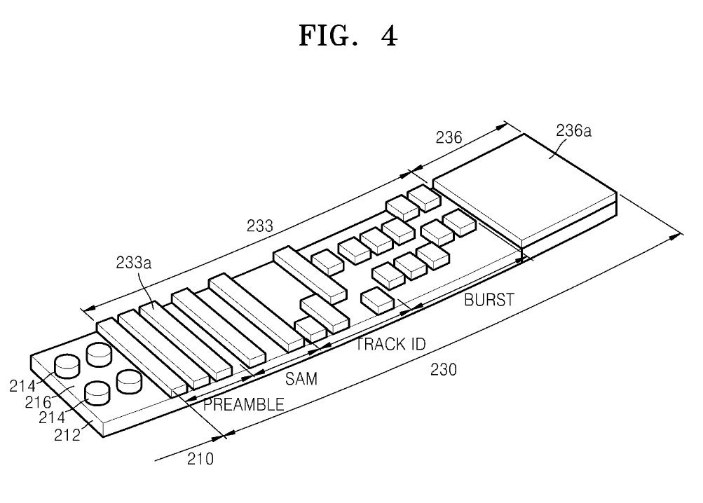

FIG. 3 is a plan view of a patterned magnetic recording medium 200 according to another exemplary embodiment of the present invention. FIG. 4 is an enlarged perspective view of an area A illustrated in FIG. 3. Referring to FIGS. 3 and 4, the patterned magnetic recording medium 200 includes a data sector 210 and a servo sector 230. The patterned magnetic recording medium 200 is similar to the patterned magnetic recording medium 100 of FIG. 1 except for the structure of the data sector 210. Thus, the patterned magnetic recording medium 200 will be described in terms of a difference between it and the patterned magnetic recording medium 100. Since the same reference numerals in the diagrams denote the same element, descriptions of the same elements illustrated in FIGS. 1 and 2 will not be repeated here.

The data sector 210 includes a plurality of magnetic recording regions 214 spaced apart from one another by grooves 216 on a substrate 212, and the magnetic recording regions 214 constitute a plurality of tracks which are each shaped like a ring. The magnetic recording regions 214 are spaced apart from one another in a cross-track direction and in a down-track direction on a bit by bit basis. Likewise, the patterned magnetic recording medium 200, in which the magnetic recording regions 214 are discrete on a bit by bit basis, is referred to as a bit patterned medium.

The servo sector 230 is a region to which servo information regarding the tracks can be written along the tracks, and includes a servo patterned region 233 and a correction code region 236, which are each provided on the tracks.

The servo patterned region 233 includes patterned magnetic recording layers 233a which are patterned in predetermined patterns, and servo information is written in the form of the patterned magnetic recording layers 233a. The correction code region 236 is used for storing an RRO correction code. Since a correction code is recorded on the correction code region 236 according to the RRO that is measured when the HDD is driven, a continuous magnetic recording layer 236a has no pattern so that the contents of the correction code can be changed. Information regarding a track that is to be actually used on the HDD is recorded on at least one track of the correction code region 236. For example, information indicating that a track #N1 is a new outermost track, and a track #N2 is a new innermost track can be recorded on the at least one track of the correction code region 236, wherein the track IDs # N1 and #N2 are previously recorded in a off-line state.

An MC region 250 is positioned on parts of track regions of the data sector 210 and the servo sector 230. Information regarding the position of the correction code region 236 can be recorded on the MC region 250, wherein information regarding the new tracks is recorded on the correction code region 236. Alternatively, the information regarding the new tracks may be recorded on the MC region 250, instead of on the correction code region 236. The MC region 250 is provided on a track in the vicinity of the center between the innermost track and the outermost track, which are selected from among the tracks that are to be actually used on the HDD.

The patterned magnetic recording media 100 and 200 have the servo patterns, respectively, which are formed in the off-line state. Also, information regarding the track range, which is to be actually used on the HDD is recorded on a predetermined region of each of the patterned magnetic recording media 100 and 200. As described above, the predetermined region is the correction code region 136 or 236 or the MC region 150 or 250, but the predetermined region can be provided at any position so long as the magnetic head can reach the predetermined region without the influence of the mechanical tolerance. The information regarding the tracks that are to be actually used can be recorded in a flash memory of a printed circuit board assembly (PCBA), instead of being recorded in a corresponding patterned magnetic recording medium. However, in a patterned magnetic recording medium in which servo information is written in the form of the servo patterns which are formed during an off-line state, information regarding tracks that are to be actually used may differ according to a head disk assembly of the corresponding HDD, and thus only a PCBA on which information regarding one head disk assembly is recorded needs to be used. On the other hand, the patterned magnetic recording media 100 and 200 according to exemplary embodiments of the present invention can be effectively used without largely changing the entire structure of the HDD.

Hereinafter, a method of recording track information onto the patterned magnetic recording medium 100 or 200 will be described.

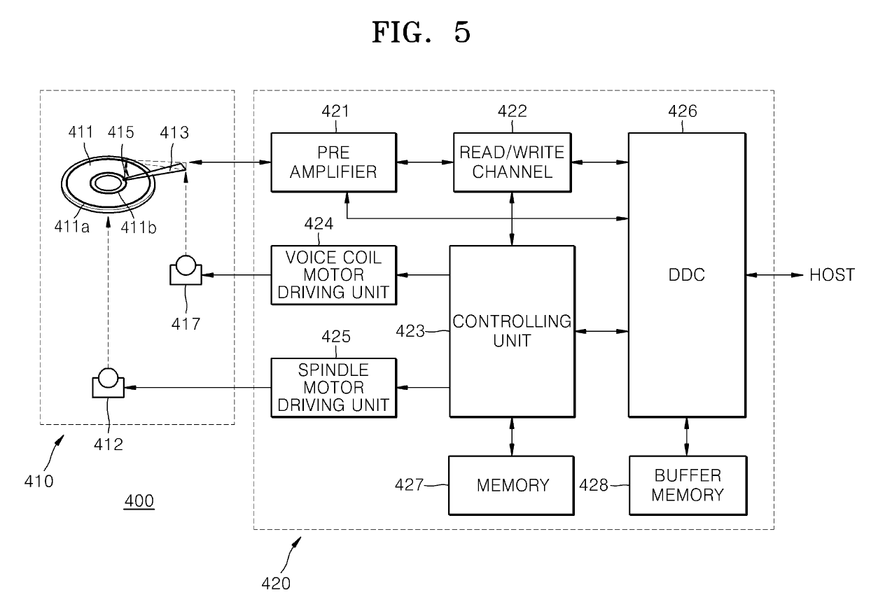

First, a schematic structure of an HDD 400 performing the method of recording the track information onto the patterned magnetic recording medium 100 or 200 will be described with reference to FIG. 5. Referring to FIG. 5, the HDD 400 performing the method of recording the track information includes a head disk assembly 410 and a circuit unit 420.

The head disk assembly 410 includes a magnetic recording medium 411 and an actuator 413. A slider having a magnetic head 415 installed thereon is installed at an end of the actuator 413. A patterned magnetic recording medium can be used as the magnetic recording medium 411, wherein servo patterns are formed during an off-line state. The magnetic recording medium 411 is rotated by a spindle motor 412. The actuator 413 is driven by a voice coil motor (VCM) 417, and the rotating range of the actuator 413 is limited by a crash stop (not shown). According to the rotating range of the actuator 413, an innermost track and an outermost track are determined, and a track range, which is to be actually used on the HDD 400, is determined.

The circuit unit 420 includes a pre amplifier 421, a read/write channel 422, a controlling unit 423, a VCM driving unit 424, a spindle motor driving unit 425, a disk data controller (DDC) 426, a memory 427 and a buffer memory 428. When data is reproduced, the pre amplifier 421 applies an analog reproducing signal, which is formed by amplifying a signal picked up from the magnetic head 415, to the read/write channel 422. When data is recorded, coded recording data, which is applied from the read/write channel 422, is recorded via the magnetic head 415 to the magnetic recording medium 411. The read/write channel 422 detects and decodes a data pulse from the reproducing signal applied from the pre amplifier 421, and then applies the data pulse to the DDC 426. In addition, the read/write channel 422 decodes the recording data applied from the DDC 426, and then applies the recording data to the pre amplifier 421. The DDC 426 functions as a communication interface between a host computer and the controlling unit 423. The buffer memory 428 is used for temporarily storing data transferred among the host computer, the controlling unit 423 and the read/write channel 422.

The magnetic head 415 reads servo information from servo patterns of the innermost track and the outermost track, which are defined according to the rotating range of the actuator 413. The servo Information read by the magnetic head 415, that is, information regarding tracks that are to be actually used is transferred via the pre amplifier 421 and the read/write channel 422 to the controlling unit 423. The controlling unit 423 applies a controlling signal for controlling the position of the magnetic head 415 to the VCM driving unit 424 by using an operation program stored in the memory 427 so that the read servo information can be written to a predetermined region of the magnetic recording medium 411.

The VCM driving unit 424 drives the VCM 417 so as to move the actuator 413 to a predetermined position according to the applied controlling signal so that the magnetic head 415 can record the information regarding tracks that are to be actually used. The magnetic head 415 records information regarding new tracks at the predetermined position.

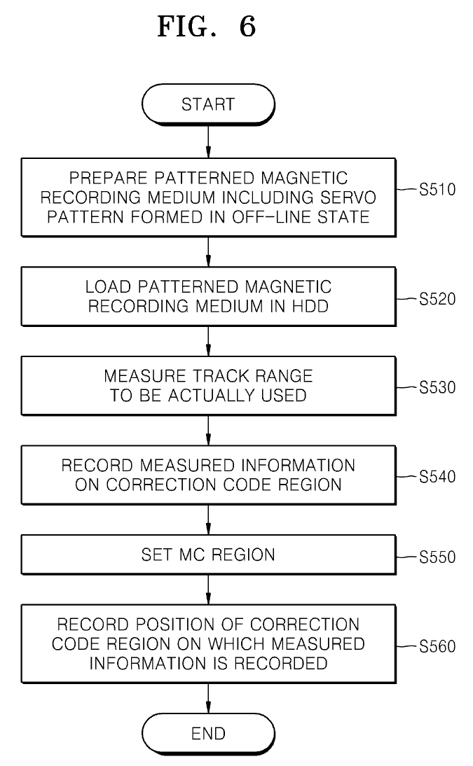

FIG. 6 is a flow chart of a method of recording track information according to an exemplary embodiment of the present invention. First, a patterned magnetic recording medium is prepared (operation S510). A discrete track medium or a bit patterned medium, which includes a data sector including a plurality of magnetic recording regions spaced apart from one another, can be used as the patterned magnetic recording medium according to the current exemplary embodiment. A servo sector of the patterned magnetic recording medium includes a servo patterned region and a correction code region, and the servo patterned region contains the servo information, which is formed during an off-line state, in the form of patterns. Next, the prepared patterned magnetic recording medium is loaded in an HDD (operation S520). A track range, which is to be actually used, is measured (operation S530). For example, the rotating range of an actuator, which is limited by a crash stop, is measured, thereby reading servo information regarding an innermost track and an outermost track, which are selected from among tracks in the track range which is to be actually used. Measured information regarding the track range is recorded on the correction code region (operation S540). The information can be recorded on at least one track of the correction code region that is selected from a plurality of tracks. The method of recording track information according to the current exemplary embodiment may further include setting an MC region (operation S550), and recording the position of the at least one track of the correction code region in the MC region (operation S560). The setting of the MC region (operation S550) may be performed prior to operation S540. In addition, the MC region may be positioned on a track in the vicinity of the center between the innermost track and the outermost track, which are measured according to the result of operation S530 in which the track range, which is to be actually used, is measured.

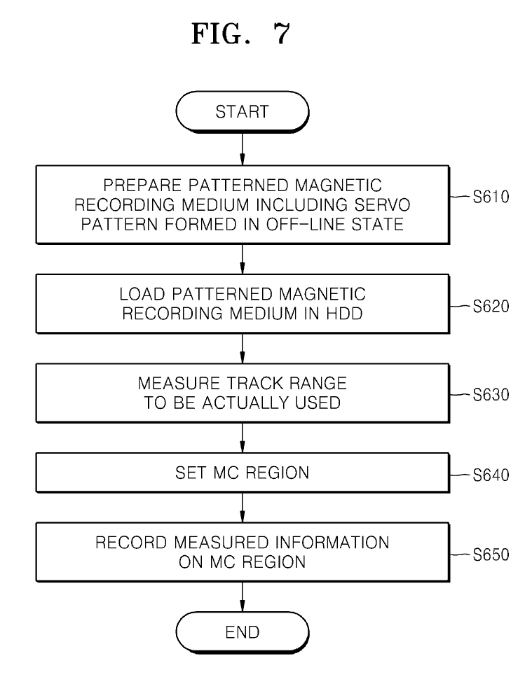

FIG. 7 is a flow chart of a method of recording track information according to another exemplary embodiment of the present invention. First, a patterned magnetic recording medium is prepared (operation S610). A discrete track medium or a bit patterned medium, which includes a data sector including a plurality of magnetic recording regions spaced apart from one another, can be used as the patterned magnetic recording medium according to the current exemplary embodiment. A servo sector of the patterned magnetic recording medium includes a servo patterned region and a correction code region, and the servo patterned region contains the servo information, which is formed during an off-line state in the form of patterns. Next, the prepared patterned magnetic recording medium is loaded on an HDD (operation S620). The track range which is to be actually used is measured (operation S630). For example, the rotating range of an actuator, which is limited by a crash stop assembly, is measured, thereby reading servo information regarding an innermost track and an outermost track of the track range, which is to be actually used. An MC region is set (operation S640). The MC region is positioned on a track in the vicinity of the center between an innermost track and an outermost track, which are measured according to the result of operation S630 in which the track range which is to be actually used, is measured. Next, measured information regarding the track range is recorded in the MC region (operation S650).

According to the above-described operations, information regarding tracks that are to be actually used in an HDD can be recorded on a patterned magnetic recording medium including servo patterns formed in an off-line state.

While a patterned magnetic recording medium and a method of recording track information onto the patterned magnetic recording medium have been particularly shown and described with regard to exemplary embodiments thereof, it will be understood by one of ordinary skill in the art that various changes in form and details may be made therein without departing from the spirit and scope of the present invention as defined by the following claims.

What is claimed is:

1. A patterned magnetic recording medium comprising:
a data sector which comprises a plurality of magnetic recording regions which are spaced apart from one another, wherein the magnetic recording regions constitute a plurality of tracks which are each shaped like a ring; and
a servo sector which comprises a plurality of servo patterned regions and a plurality of correction code regions, which are provided on the plurality of tracks, wherein information regarding a track that is to be actually used in a hard disk drive (HDD) is recorded on a correction code region of at least one track of the plurality of tracks.

2. The medium of claim 1, wherein a continuous magnetic recording layer is formed on the correction code region.

3. The medium of claim 1, wherein a repeatable runout correction code is not recorded on the correction code region on which the information regarding the track that is to be actually used is recorded.

4. The medium of claim 1, wherein a repeatable runout correction code is simultaneously recorded in the correction code region on which the information regarding the track that is to be actually used is recorded.

5. The medium of claim 1, wherein information regarding a position of the correction code region on which the information regarding the track that is to be actually used is recorded, is recorded in a maintenance cylinder (MC) region.

6. The medium of claim 5, wherein the MC region is positioned on a track in a vicinity of a center between an innermost track and an outermost track, which are selected from among tracks that are to be actually used.

7. The medium of claim 1, wherein the patterned magnetic recording medium is a discrete track medium in which a plurality of magnetic recording regions are discrete on a track by track basis.

8. The medium of claim 1, wherein the patterned magnetic recording medium is a bit patterned medium in which a plurality of magnetic recording regions are discrete on a bit by bit basis.

9. A patterned magnetic recording medium comprising:
a data sector which comprises a plurality of magnetic recording regions which are spaced apart from one another, wherein the magnetic recording regions constitute a plurality of tracks which are each shaped like a ring;
a servo sector which comprises a plurality of servo patterned regions which are provided on the plurality of tracks; and
a maintenance cylinder (MC) region for recording information required for driving a hard disk drive (HDD) on a part of the plurality of tracks,
wherein information regarding a track that is to be actually used in the HDD is recorded in the MC region.

10. The medium of claim 9, wherein the MC region is positioned on a track in a vicinity of a center between an innermost track and an outermost track, which are selected from among tracks that are to be actually used.

11. The medium of claim 9, wherein the patterned magnetic recording medium is a discrete track medium in which a plurality of magnetic recording regions are discrete on a track by track basis.

12. The medium of claim 9, wherein the patterned magnetic recording medium is a bit patterned medium in which a plurality of magnetic recording regions are discrete on a bit by bit basis.

13. A method of recording track information, the method comprising:
preparing a patterned magnetic recording medium which comprises a data sector and a servo sector, wherein the data sector comprises a plurality of magnetic recording regions spaced apart from one another, the servo sector comprises a servo patterned region and a correction code region, the magnetic recording regions constitute a plurality of tracks which are each shaped like a ring, and the servo patterned region and the correction code region are provided on each of the plurality of tracks;
loading the patterned magnetic recording medium in a hard disk drive (HDD) and measuring a track range which is to be actually used in the HDD; and
recording information regarding the measured track range on the correction code region of at least one track of the plurality of tracks.

14. The method of claim 13, further comprising:
setting a maintenance cylinder (MC) region on a track in a vicinity of a center between an innermost track and an outermost track within the track range.

15. The method of claim 14, further comprising:
recording information regarding a position of a the correction code region, in which the information regarding the measured track range is recorded, in the MC region.

16. A method of recording track information, the method comprising:
preparing a patterned magnetic recording medium which comprises a data sector and a servo sector, wherein the data sector comprises a plurality of magnetic recording regions spaced apart from one another, the servo sector comprises servo patterned regions, the magnetic recording regions constitute a plurality of tracks which are each shaped like a ring, and the servo patterned regions are each provided on the plurality of tracks;
loading the patterned magnetic recording medium in a hard disk drive (HDD) and measuring a track range which is to be actually used in the HDD; and
setting a maintenance cylinder (MC) region on a track in a vicinity of the center between an innermost track and an outermost track within the track range which is to be actually used.

17. The method of claim 16, further comprising:
recording information regarding the measured track range on the MC region.
